(19) United States
(12) Patent Application Publication
(10) Pub. No.: US 2009/0241882 A1
(43) Pub. Date: Oct. 1, 2009

(54) METHOD FOR INCREASING THE VISCOSITY OF AUTOMOTIVE FUEL COMPOSITIONS

(76) Inventors: Andreas Hugo Brunner, Hamburg (DE); Jurgen Johannes Jacobus Louis, Hamburg (DE); Andreas Schafer, Hamburg (DE)

Correspondence Address: SHELL OIL COMPANY, P O BOX 2463, HOUSTON, TX, 772522463, US

(21) Appl. No.: 12/411,512

(22) Filed: Mar. 26, 2009

(30) Foreign Application Priority Data
Mar. 26, 2008 (EP) 08102907.6

(51) Int. Cl. F02B 43/00; C10L 1/16

(52) U.S. Cl. 123/1 A; 44/459

(57) ABSTRACT

A certain viscosity index (VI) improving additive may be used to increase the viscosity of an autoamotive fuel composition, by an amount greater than that which theory would have predicted to occur to improve the acceleration performance of an internal combustion engine into which the fuel composition is introduced. The fuel composition is suitably a diesel fuel composition, and the additive suitably comprises a block copolymer which contains one or more monomer blocks selected from ethylene, propylene, butylene, butadiene, isoprene and styrene monomers. The additive is preferably used in the composition at a concentration of 0.5 % w/w or lower.

This application claims the benefit of European Application No. 08102907.6 filed 26 March 2008.

### FIELD OF THE INVENTION

The present invention relates to methods for improving the performance of internal combustion engines, in particular diesel engines.

### BACKGROUND OF THE INVENTION

Many vehicle engines are equipped with turbo chargers, which improve their power output by increasing the amount of air entering the combustion cylinders. Operation of the turbo charger is typically regulated by the vehicle's engine management system.

Whilst with less sophisticated engines it was often possible to improve performance by optimising the content and/or properties of the fuels introduced into them, the options for improving performance through fuel formulation tend to be more limited for modern turbo charged engines, since engine management systems are often programmed to compensate for changes in fuel intake.

WO-A-2005/054411 describes the use of a viscosity increasing component in a diesel fuel composition, for the purpose of improving the vehicle tractive effort (VTE) and/or acceleration performance of a diesel engine into which the composition is introduced. The document exemplifies improvements in average wide open throttle (WOT) acceleration times, over engine speed ranges from around 1300 rpm upwards, and in steady state vehicle tractive effort (VTE) tests at constant engine speeds of 2000 rpm and above, for both turbo charged and non-turbo charged engines. The components used to increase the viscosity of the fuel composition include hydrocarbon diesel fuel components such as in particular Fischer-Tropsch derived diesel components, and oils, which may be mineral or synthetic in origin and may also be Fischer-Tropsch derived.

In order to have a significant effect on fuel viscosity, and hence on engine performance, such additional components typically need to be used at concentrations of at least 5 % w/w, often higher. Some of them can however, in particular at higher concentrations, have a negative impact on other fuel properties, for example distillation or cold flow properties, potentially making it difficult to keep the resultant fuel composition within a desired specification.

Increasing the viscosity of an automotive fuel composition is no trivial matter. The incorporation of additional fuel components, as proposed in WO-A-2005/054411, can impact on refinery operation and on fuel supply, storage and distribution systems. This can increase fuel supply costs, and in some markets can be extremely difficult to achieve, if, for example, the producer has little control over the-base fuel itself. Moreover, the more obvious viscosity increasing components may also be of limited availability.

It is also of note that WO-A-2005/054411 makes no specific mention of improving acceleration performance at lower engine speeds. Yet it is at the lower speeds where a driver might be more likely to notice improvements in acceleration response.

It would be desirable to be able to further improve the performance of a vehicle engine, in particular a turbo charged engine, by altering the composition and/or properties of the fuel introduced into it, as this can be expected to provide a more simple, flexible and cost effective route to performance optimisation than by making structural or operational changes to the engine itself.

### SUMMARY OF THE INVENTION

A method for increasing the viscosity of an automotive fuel composition to achieve a target minimum viscosity is provided, comprising adding to the composition a concentration c of a VI improving additive which comprises a block copolymer which contains one or more monomer blocks selected from ethylene, propylene, butylene, butadiene, isoprene and styrene monomers, wherein c is lower than the minimum concentration c′ of the VI improving additive which theory would predict would need to be added to the composition in order to achieve a viscosity for the composition of X or greater where c is 0.5 % w/w or lower. A method of operating a turbo charger with a fuel composition prepared by such method is also provided.

The fuel composition is preferably a diesel fuel composition and the internal combustion engine is preferably a diesel engine, in particular a turbo charged diesel engine.

By “diesel engine” is meant a compression ignition internal combustion engine, which is adapted to run on a diesel fuel. By “turbo charged diesel engine” is meant a diesel engine which is powered via a turbo charger, typically under the control of an electronic engine management system.

“Acceleration performance” includes generally the responsiveness of the engine to increased throttle, for example the rate at which it accelerates from any given engine speed. It includes the level of power and/or torque and/or vehicle tractive effort (VTE) generated by the engine at any given speed. Thus an improvement in acceleration performance may be manifested by an increase in engine power and/or torque and/or VTE at any given speed.

The present invention may be used to improve acceleration performance at low engine speeds. “Low engine speeds” means speeds generally up to 2200 rpm, in particular up to 2000 rpm, for example from 500 to 2200 rpm or from 1200 or 1400 to 2200 rpm or from 1200 or 1400 to 2000 rpm. A “low engine speed” may, in a turbo charged engine, be a speed below the level at which the engine management system which controls operation of the turbo charger begins to restrict the boost provided by the turbo charger and/or to regulate the engine charge air pressure.

It has been found that even under the control of the engine management system, fuels containing VI improving additives can give performance benefits in turbo charged engines, and that these benefits can also apply at low engine speeds (for example in the ranges referred to above). This is by no means predictable from the generally higher speed data in WO-A-2005/054411, which in the case of the VTE figures were obtained at fixed speeds and in the case of the WOT acceleration times were averaged over engine speeds of up to 3500 rpm or higher. The performance advantages provided by the present invention can, for instance, affect the ramp-up of a turbo charger, a transient effect observed when accelerating through the lower speed ranges, whereas the investigations described in WO-A-2005/054411 were directed more towards steady state engine conditions.

It might also have been expected that higher viscosity fuels could impair engine performance, for instance by detrimentally impacting upon the injected fuel spray, thus reducing the rate of fuel evaporation and in turn causing power loss, and/or by increasing pumping losses in the fuel injection equipment. It has instead been found that the benefits of including a VI improving additive in an automotive fuel can override any such potentially detrimental effects.

Subsequent investigations have led to the hypothesis that a higher viscosity fuel can cause faster revving up of a turbo charger, which can thus reach its maximum speed at a lower engine speed. In modern turbo charged engines, the turbo charger speed accelerates as load and engine speed increase, until a predetermined maximum turbo charger speed is attained. An “early” boost to the engine, with the turbo charger speed increasing more rapidly at lower engine speeds, may in turn cause a discernable improvement in acceleration performance at lower engine speeds, which the driver will experience as a faster “pick-up” or acceleration response. This effect may in part contribute to the improved acceleration performance observed when using a fuel composition prepared according to the present invention.

It has also now been found that the engine management system (EMS) may in some cases reinforce this effect. Under full load acceleration, the use of a higher viscosity fuel can lead to an increase in the quantity of fuel injected, with more energy therefore being retained in the exhaust gases that drive the turbo charger. This in turn results in higher pressure air entering the engine and therefore an increased air intake charge. The engine management system is likely to react to this by injecting more fuel, thus driving the turbo charger even faster. This positive feedback loop is halted when the turbo charger reaches its maximum speed and the engine management system then applies controls to limit boost and regulate the charge air pressure. These effects are now believed to explain why the performance benefits observed using higher viscosity fuels can sometimes be amplified at lower engine speeds.

At higher engine speeds, charge air pressure is more closely controlled by the EMS and the performance benefits of a higher viscosity fuel might then be expected to be reduced and/or less readily detectable. However, it has been found that VI improving additives can retain their performance improving effects at higher engine speeds (for example 2000 rpm or greater, or 2200 or 2500 or even 3000 or 3200 or 3400 or 3500 or greater) as well as lower ones.

Thus, the present invention may be used to boost the performance of a turbo charger, at low engine speeds, typically to an extent greater than that which might have been expected based solely on the properties of a fuel composition and a VI improving additive used in it. It may also, however, be used to maintain improved performance at higher engine speeds, ideally across the entire engine speed range.

The present invention may involve use of the VI improving additive for the purpose of reducing the engine speed at which a turbo charger reaches its maximum speed when accelerating, or of increasing the rate at which a turbo charger increases its speed (in particular at low engine speeds) or reducing the time taken for the turbo charger to reach its maximum speed. It may be used to increase the charge air pressure (boost pressure) at a given engine speed, again especially at low engine speeds.

Engine speeds can conveniently be measured by interrogation of the engine management system during controlled acceleration tests. They may alternatively be measured using a dynamometer. Acceleration performance tests are typically conducted at wide open throttle.

Turbo charger speed is related to the engine air intake pressure (i.e. the boost pressure from the turbo charger), which can either be measured using conventional pressure sensors (for instance positioned in the intake track of a vehicle powered by the engine under test, immediately downstream of the turbo charger), or in some cases by interrogation of the engine management system. This in turn can allow determination of the point when the turbo charger reaches its maximum speed, or of the rate of increase in turbo charger speed.

Engine torque may be derived from the force exerted on a dynamometer by the wheel(s) of a vehicle which is powered by the engine under test. It may, using suitably specialised equipment (for example the Kistler™ RoaDyn™), be measured directly from the wheels of such a vehicle. Engine power may suitably be derived from measured engine torque and engine speed values, as is known in the art. VTE may be measured by measuring the force exerted, for example on the roller of a chassis dynometer, by the wheels of a vehicle driven by the engine.

The present invention can be of use in improving the acceleration performance of an internal combustion engine or of a vehicle powered by such an engine. Acceleration performance may be assessed by accelerating the engine and monitoring changes′ in engine speed, power, torque and/or VTE, air charge pressure and/or turbo charger speed with time. This assessment may suitably be carried out over a range of engine speeds; where an improvement in low speed performance is desired, the assessment may for instance be carried out at speeds from 1200 to 2000 rpm or from 1400 to 1900 rpm.

Acceleration performance may also be assessed by a suitably experienced driver accelerating a vehicle which is powered by the engine under test, for instance from 0 to 100 km/hour, on a road. The vehicle should be equipped with appropriate instrumentation such as an engine speedometer, to enable changes in acceleration performance to be related to engine speed.

In general, an improvement in acceleration performance may be manifested by reduced acceleration times, and/or by any one or more of the effects described above for example a faster increase in turbo charger speed, or an increase in engine torque or power or VTE at any given speed.

In the context of the present invention, an “improvement” in acceleration performance embraces any degree of improvement. Similarly a reduction or increase in a measured parameter—for example the time taken for the turbo charger to reach its maximum speed—embraces any degree of reduction or increase, as the case may be. The improvement, reduction or increase—as the case may be—may be as compared to the relevant parameter when using the fuel composition prior to incorporation of the VI improving additive, or when using an otherwise analogous fuel composition of lower viscosity. It may be as compared to the relevant parameter measured when the same engine is run on an otherwise analogous fuel composition which is intended (e.g. marketed) for use in an internal combustion (typically diesel) engine, prior to adding a VI improving additive to it.

The present invention may, for example, involve adjusting the properties and/or performance and/or effects of the fuel composition, in particular its effect on the acceleration performance of an internal combustion engine, by means of the VI improving additive, in order to meet a desired target.

As described in WO-A-2005/054411 (see in particular page 3, line 22 to page 4, line 17), an improvement in acceleration performance may also embrace mitigation, to at least a degree, of a decrease in acceleration performance due to another cause, in particular due to another fuel component or additive included in the fuel composition. By way of example, a fuel composition may contain one or more components intended to reduce its overall density so as to reduce the level of emissions which it generates on combustion; a reduction in density can result in loss of engine power, but this effect may be overcome or at least mitigated by the use of a VI improving additive in accordance with the present invention.

An improvement in acceleration performance may also embrace restoration, at least partially, of acceleration performance which has been reduced for another reason such as the use of a fuel containing an oxygenated component (e.g. a so-called “biofuel”), or the build-up of combustion related deposits in the engine (typically in the fuel injectors).

Where the present invention is used to increase the engine torque, typically during a period of acceleration, at a given engine speed, the increase may be of at least 0.1%, preferably of at least 0.2 or 0.3 or 0.4 or 0.5%, in cases of at least 0.6 or 0.7%, compared to that obtained when running the engine on the fuel composition prior to incorporation of the VI improving additive, and/or when running the engine on an otherwise analogous (typically diesel) fuel composition of lower viscosity. The increase may be as compared to the engine torque obtained at the relevant speed when the same engine is run on an otherwise analogous fuel composition which is intended (e.g. marketed) for use in an internal combustion (typically diesel) engine, in particular a turbo charged engine, prior to adding a VI improving additive to it.

Where the present invention is used to increase the engine power, typically during a period of acceleration, at a given engine speed, the increase may again be of at least 0.1%, preferably of at least 0.2 or 0.3 or 0.4 or 0.5%, in cases of at least 0.6 or 0.7%, compared to that obtained when running the engine on the fuel composition prior to incorporation of the VI improving additive, and/or when running the engine on an otherwise analogous (typically diesel) fuel composition of lower viscosity. The increase may be as compared to the engine power obtained at the relevant speed when the same engine is run on an otherwise analogous fuel composition which is intended (e.g. marketed) for use in an internal combustion (typically diesel) engine, in particular a turbo charged engine, prior to adding a VI improving additive to it.

Where the present invention is used to increase the engine VTE, typically during a period of acceleration, at a given engine speed, the increase may again be of at least 0.1%, preferably of at least 0.2 or 0.3 or 0.4 or 0.5%, in cases of at least 0.6 or 0.7%, compared to that obtained when running the engine on the fuel composition prior to incorporation of the VI improving additive, and/or when running the engine on an otherwise analogous (typically diesel) fuel composition of lower viscosity. The increase may be as compared to the VTE obtained at the relevant speed when the same engine is run on an otherwise analogous fuel composition which is intended (e.g. marketed) for use in an internal combustion (typically diesel) engine, in particular a turbo charged engine, prior to adding a VI improving additive to it.

Where the present invention is used to increase the turbo charger boost pressure in a turbo charged engine, typically during a period of acceleration (i.e. during turbo charger ramp-up), at a given engine speed, the increase may be of at least 0.3%, preferably of at least 0.4 or 0.5%, compared to that obtained when running the engine on the fuel composition prior to incorporation of the VI improving additive, and/or when running the engine on an otherwise analogous (typically diesel) fuel composition of lower viscosity. The increase may be as compared to the turbo charger boost pressure at the relevant speed when the same engine is run on an otherwise analogous fuel composition which is intended (e.g. marketed) for use in an internal combustion (typically diesel) engine, in particular a turbo charged engine, prior to adding a VI improving additive to it.

Where the present invention is used to reduce the time taken for the engine to accelerate between two given engine speeds, the reduction may be of at least 0.1%, preferably of at least 0.2 or 0.3 or 0.4 or 0.5%, in cases of at least 0.6.or 0.7 or 0.8 or 0.9%, compared to that taken when running the engine on the fuel composition prior to incorporation of the VI improving additive, and/or when running the engine on an otherwise analogous (typically diesel) fuel composition of lower viscosity. The reduction may be as compared to the acceleration time between the relevant speeds when the same engine is run on an otherwise analogous fuel composition which is intended (e.g. marketed) for use in an internal combustion (typically diesel) engine prior to adding a VI improving additive to it. Such acceleration times may for instance be measured over an engine speed increase of 300 rpm or more, or of 400 or 500 or 600 or 700 or 800 or 900 or 1000 rpm or more, for example from 1300 to 1600 rpm, or from 1600 to 2200 rpm, or from 2200 to 3000 rpm, or from 3000 to 4000 rpm.

The VI improving additive is preferably used at a minimum temperature of 40° C. Moreover, the VI improving additive is preferably used at a minimum pressure of 250 bar.

The automotive fuel composition in which the VI improving additive is used, in accordance with the present invention, may in particular be a diesel fuel composition suitable for use in a diesel engine. It may be used in, and/or may be suitable and/or adapted and/or intended for use in, any type of compression ignition engine, for instance those described below. It may in particular be suitable for use in a diesel engine equipped with a turbo charger.

Viscosity index improving additives (also referred to as VI improvers) are already well known for use in lubricant formulations, where they are used to maintain viscosity as constant as possible over a desired temperature range by increasing viscosity at higher temperatures. They are typically based on relatively high molecular weight, long chain polymeric molecules that can form conglomerates and/or micelles. These molecular systems expand at higher temperatures, thus further restricting their movement relative to one another and in turn increasing the viscosity of the system.

Known VI improvers include polymethacrylates (PMAs), polyisobutylenes (PIBs), styrene-butylene/ethylene block copolymers, and certain other copolymers including for instance polystyrene-polyisoprene stellate (“star”) copolymers. They are typically included in lubricating oil formulations at concentrations between 1 and 20% w/w.

In WO-A-01/48120, certain of these types of additive are proposed for use in fuel compositions, in particular diesel fuel compositions, for the purpose of improving the ability of an engine to start at elevated temperatures. They have not, however, to our knowledge, been proposed for use in improving the acceleration performance of an engine.

It has now been found that VI improving additives can significantly increase the viscosity of an automotive, in particular diesel, fuel composition, even when used at relatively low concentrations, and in turn can improve the performance of an engine into which the composition is introduced. These performance improvements can be particularly noticeable at low engine speeds, as described in more detail below. They may apply in particular to turbo charged engines.

Thus, the present invention can provide an effective way of improving the performance of an internal combustion engine by means of the fuel introduced into it. In contrast to the diesel fuel compositions disclosed in WO-A-2005/054411, however, the present invention allows optimisation of a fuel using relatively low concentrations of additional components (i.e. concentrations of the order of those used for fuel additives rather than for fuel components such as those used to increase viscosity in WO-A-2005/054411). This in turn can reduce the cost and complexity of the fuel preparation process. For example, it can allow a fuel composition to be altered, in order to improve subsequent engine performance, by the incorporation of additives downstream of the refinery, rather than by altering the content of the base fuel at its point of preparation. The blending of base fuel components may not be feasible at all locations, whereas the introduction of fuel additives, at relatively low concentrations, can more readily be achieved at fuel depots or at other filling points such as road tanker, barge or train filling points, dispensers, customer tanks and vehicles. Moreover, an additive which is to be used at a relatively low concentration can naturally be transported, stored and introduced into a fuel composition more cost effectively than can a fuel component which needs to be used at concentrations of the order of tens of percent by weight.

The use of relatively low concentrations of VI improving additives can also help to reduce any undesirable side effects—for example impacting on distillation or cold flow properties—caused by their incorporation into a fuel composition.

VI improving additives tend to be synthetically prepared, and are therefore typically available with a well defined constitution and quality, in contrast to, for example, mineral derived viscosity increasing fuel components (refinery streams), the constitution of which can vary from batch to batch. VI improving additives are also widely available, for use in lubricants, which can again make them an attractive additive for the new use proposed by the present invention. They are also often less expensive, in particular in view of the lower concentrations needed, than other viscosity increasing components such as mineral base oils.

A further advantage of the present invention is that VI improving additives are designed specifically to increase viscosity at higher temperatures. Since increases in engine power due to the use of higher viscosity fuels are linked to the conditions in the fuel injection system, which generally operates at high temperatures, VI improving additives are believed capable of providing greater performance benefits than other more conventional viscosity increasing components.

The VI improving additive used in a fuel composition in accordance with the present invention may be polymeric in nature. It may, for example, be selected from:
a) styrene-based copolymers, in particular block copolymers, for example those available as Kraton™ D or Kraton™ G additives (ex. Kraton) or as SV™ additives (ex. Infineum, Multisol or others). Particular examples include copolymers of styrenic and ethylene/butylene monomers, for instance polystyrene-polyisoprene copolymers and polystyrene-polybutadiene copolymers. Such copolymers may be block copolymers, as for instance SV™ 150 (a polystyrene-polyisoprene di-block copolymer) or the Kraton™ additives (styrene-butadiene-styrene tri-block copolymers or styrene-ethylene-butylene block copolymers). They may be tapered copolymers, for instance styrene-butadiene copolymers. They may be stellate copolymers, as for instance SV™ 260 (a styrene-polyisoprene star copolymer);
b) other block copolymers based on ethylene, butylene, butadiene, isoprene or other olefin monomers, for example ethylene-propylene copolymers;
c) polyisobutylenes (PIBs);
d) polymethacrylates (PMAs);
e) poly alpha olefins (PAOs); and
f) mixtures thereof.

A VI improving additive may include one or more compounds of inorganic origin, for example zeolites.

Other examples of suitable viscosity index improvers are disclosed in Japanese Patents Nos. 954077, 1031507, 1468752, 1764494 and 1751082. Yet further examples include the dispersing-type VI improvers which comprise copolymerised polar monomers containing nitrogen and oxygen atoms; alkyl aromatic-type VI improvers; and certain pour point depressants known for use as VI improvers.

Of the above, additives of type (a) and (b), or mixtures thereof, may be preferred, in particular additives of type (a). VI improving additives which contain, or ideally consist essentially of, block copolymers, may be preferred, as in general these can lead to fewer side effects such as increases in deposit and/or foam formation.

The VI improving additive may, for example, comprise a block copolymer which contains one or more olefin monomer blocks, typically selected from ethylene, propylene, butylene, butadiene, isoprene and styrene monomers.

The kinematic viscosity at 40° C. (VK 40, as measured by ASTM D-445 or EN ISO 3104) of the VI improving additive is suitably 40 mm²/s or greater, preferably 100 mm²/s or greater, more preferably 1000 mm²/s or greater. Its density at 15° C. (ASTM D-4052 or EN ISO 3675) is suitably 600 kg/m³ or greater, preferably 800 kg/m³ or greater. Its sulphur content (ASTM D-2622 or EN ISO 20846) is suitably 1000 mg/kg or lower, preferably 350 mg/kg or lower, more preferably 10 mg/kg or lower.

The VI improving additive may be pre-dissolved in a suitable solvent, for example an oil such as a mineral oil or Fischer-Tropsch derived hydrocarbon mixture;a fuel component (which again may be either mineral or Fischer-Tropsch derived) compatible with the fuel composition in which the additive is to be used (for example a middle distillate fuel component such as a gas oil or kerosene, when intended for use in a diesel fuel composition); a poly alpha olefin; a so-called biofuel such as a fatty acid alkyl ester (FAAE), a Fischer-Tropsch derived biomass-to-liquid synthesis product, a hydrogenated vegetable oil, a waste or algae oil or an alcohol such as ethanol; an aromatic solvent; any other hydrocarbon or organic solvent; or a mixture thereof. Preferred solvents for use in this context are mineral oil based diesel fuel components and solvents, and Fischer-Tropsch derived components such as the “XtL” components referred to below. Biofuel solvents may also be preferred in certain cases.

The concentration of the VI improving additive in the fuel composition may be up to 1% w/w, suitably up to 0.5% w/w, in cases up to 0.4 or 0.3 or 0.25% w/w. It may be 0.001% w/w or greater, preferably 0.01% w/w or greater, suitably 0.02 or 0.03 or 0.04 or 0.05% w/w or greater, in cases 0.1 or 0.2% w/w or greater. Suitable concentrations may for instance be from 0.001 to 1% w/w, or from 0.001 to 0.5% w/w, or from 0.05 to 0.5% w/w, or from 0.05 to 0.25% w/w, for example from 0.05 to 0.25% w/w or from 0.1 to 0.2% w/w. Surprisingly it has been found that higher concentrations of VI improving additives (for instance, higher than 0.5% w/w) do not always lead to improved engine performance, and that in cases there may be an optimum concentration for any given additive, for instance between 0.05 and 0.5% w/w or between 0.05 and 0.25% w/w or between 0.1 and 0.2% w/w.

The remainder of the composition will typically consist of one or more automotive base fuels, for instance as described in more detail below, optionally together with one or more fuel additives.

The above concentrations are for the VI improving additive itself, and do not take account of any solvent(s) with which its active ingredient is pre-diluted. They are based on the mass of the overall fuel composition. Where a combination of two or more VI improving additives is used in the composition, the same concentration ranges may apply to the overall combination, again minus any pre-solvent(s) present.

The concentration of the VI improving additive will depend on the desired viscosity of the overall fuel composition, the viscosity of the composition prior to incorporation of the additive, the viscosity of the additive itself and the viscosity of any solvent in which the additive is used. The relative proportions of the VI improving additive, fuel component(s) and any other components or additives present, in an automotive fuel composition prepared according to the present invention, may also depend on other desired properties such as density, emissions performance and cetane number, in particular density.

It has been found that, at least at the relatively low concentrations proposed for use in the present invention, a VI improving additive can increase the viscosity of a fuel composition, in particular a diesel fuel composition, by an amount greater than that which theory would predict based on the viscosities of the individual components.

According to such a theory, the viscosity of a blend of two or more liquids having different viscosities can be calculated using a three-step procedure (see Hirshfelder et al, “Molecular Theory of Gases and Liquids”, First Edition, Wiley (ISBN 0-471-40065-3) and Maples (2000), “Petroleum Refinery Process Economics”, Second Edition, Pennwell Books (ISBN 0-87814-779-9)). The first step requires calculation of the viscosity blending index (VBI) for each component of the blend, using the following equation (known as a Refutas equation):

VBI=14.534×1n [1n (v+0.8)]+10.975 (1),

where v is the viscosity of the relevant component in centistokes (mm²/s), and is measured at the same temperature for each component.

The next step is to calculate the VBI for the overall blend, using the following equation:

VBI_{blend}=[w_{A}×VBI_{A}]+[w_{B}×VBI_{B}]+ . . . +[w_{X}×VBI_{X}] (2),

where the blend contains components A, B . . . X and each w is the weight fraction (i.e. % w/w . 100) of the relevant component in the blend.

Once the viscosity blending index of the blend has been calculated using equation (2), the final step is to determine the viscosity of the blend using the inverse of equation (1):

v=êê((VBI_{blend}−10.975)÷14.534)−0.8 (3).

However, it has been found that a blend of 99% w/w of a sulphur free diesel fuel having a VK 40 of 2.75 mm²/s with 1% w/w of the VI improving additive SV™ 261 (which has a VK 40 of 16300 mm²/s) has an overall measured VK 40 of 3.19 mm²/s. In other words, incorporation of the VI improver increases the VK 40 of the diesel fuel by 0.44 mm²/s. Using the above formulae, however, the theoretical VK 40 of such a blend would be 2.84 mm²/s, i.e. an increase of only 0.09 mm²/s over the VK 40 of the diesel fuel alone. Thus, based purely on theory, VI improving additives would not be expected significantly to increase the viscosity of a fuel composition at additive-level concentrations.

(SV™ 261 is a mixture of 15% w/w block copolymers (e.g. SV™ 260, also ex. Infineum) with 85% w/w mineral oil.)

Due to the inclusion of the VI improving additive, a fuel composition prepared according to the present invention (in particular a diesel fuel composition) will suitably have a VK 40 of 2.7 or 2.8 mm²/s or greater, preferably 2.9 or 3.0 or 3.1 or 3.2 or 3.3 or 3.4 mm²/s or greater, in cases 3.5 or 3.6 or 3.7 or 3.8 or 3.9 or even 4 mm²/s or greater. Its VK 40 may be up to 4.5 or 4.4 or 4.3 mm²/s. In certain cases, for example arctic diesel fuels, the VK 40 of the composition may be as low as 1.5 mm²/s, although it is preferably 1.7 or 2.0 mm²/s or greater. References in this specification to viscosity are, unless otherwise specified, intended to mean kinematic viscosity.

The composition preferably has a relatively high density, for example for a diesel fuel composition 830 kg/m³ or greater at 15° C. (ASTM D-4052 or EN ISO 3675), preferably 832 kg/m³ or greater, such as from 832 to 860 kg/m³. Suitably its density will be no higher than 845 kg/m³ at 15° C., which is the upper limit of the current EN 590 diesel fuel specification.

A fuel composition prepared according to the present invention may be for example an automotive gasoline or diesel fuel composition, in particular the latter.

A gasoline fuel composition prepared according to the present invention may in general be any type of gasoline fuel composition suitable for use in a spark ignition (petrol) engine. It may contain, in addition to the VI improving additive, other standard gasoline fuel components. It may, for example, include a major proportion of a gasoline base fuel, which will typically have a boiling range (ASTM D-86 or EN ISO 3405) of from 20 to 210° C. A “major proportion” in this context means typically 85% w/w or greater based on the overall fuel composition, more suitably 90 or 95% w/w or greater, most preferably 98 or 99 or 99.5% w/w or greater.

A diesel fuel composition prepared according to the present invention may in general be any type of diesel fuel composition suitable for use in a compression ignition (diesel) engine. It may contain, in addition to the VI improving additive, other standard diesel fuel components. It may, for example, include a major proportion of a diesel base fuel, for instance of the type described below. Again a “major proportion” means typically 85% w/w or greater based on the overall composition, more suitably 90 or 95% w/w or greater, most preferably 98 or 99 or 99.5% w/w or greater.

Thus, in addition to the VI improving additive, a diesel fuel composition prepared according to the present invention may comprise one or more diesel fuel components of conventional type. Such components will typically comprise liquid hydrocarbon middle distillate fuel oil(s), for instance petroleum derived gas oils. In general such fuel components may be organically or synthetically derived, and are suitably obtained by distillation of a desired range of fractions from a crude oil. They will typically have boiling points within the usual diesel range of 150 to 410° C. or 170 to 370° C., depending on grade and use. Typically the fuel composition will include one or more cracked products, obtained by splitting heavy hydrocarbons.

A petroleum derived gas oil may for instance be obtained by refining and optionally (hydro)processing a crude petroleum source. It may be a single gas oil stream obtained from such a refinery process or a blend of several gas oil fractions obtained in the refinery process via different processing routes. Examples of such gas oil fractions are straight run gas oil, vacuum gas oil, gas oil as obtained in a thermal cracking process, light and heavy cycle oils as obtained in a fluid catalytic cracking unit and gas oil as obtained from a hydrocracker unit. Optionally a petroleum derived gas oil may comprise some petroleum derived kerosene fraction.

Such gas oils may be processed in a hydrodesulphurisation (HDS) unit so as to reduce their sulphur content to a level suitable for inclusion in a diesel fuel composition.

A diesel base fuel may be or comprise a Fischer-Tropsch derived diesel fuel component, typically a Fischer-Tropsch derived gas oil. In the context of the present invention, the term “Fischer-Tropsch derived” means that a material is, or derives from, a synthesis product of a Fischer-Tropsch condensation process. The term “non-Fischer-Tropsch derived” may be interpreted accordingly. A Fischer-Tropsch derived fuel or fuel component will therefore be a hydrocarbon stream in which a substantial portion, except for added hydrogen, is derived directly or indirectly from a Fischer-Tropsch condensation process.

The Fischer-Tropsch reaction converts carbon monoxide and hydrogen into longer chain, usually paraffinic, hydrocarbons:

n(CO+2H₂)=(—CH₂—)ₙ+nH₂O+heat,

in the presence of an appropriate catalyst and typically at elevated temperatures (e.g. 125 to 300° C., preferably 175 to 250° C.) and/or pressures (e.g. 0.5 to 10 MPa, preferably 1.2 to 5 MPa). Hydrogen:carbon monoxide ratios other than 2:1 may be employed if desired.

The carbon monoxide and hydrogen may themselves be derived from organic, inorganic, natural or synthetic sources, typically either from natural gas or from organically derived methane.

A Fischer-Tropsch derived diesel fuel component of use in the present invention may be obtained directly from the refining or the Fischer-Tropsch reaction, or indirectly for instance by fractionation or hydrotreating of the refining or synthesis product to give a fractionated or hydrotreated product. Hydrotreatment can involve hydrocracking to adjust the boiling range (see e.g. GB-B-2077289 and EP-A-0147873) and/or hydroisomerisation which can improve cold flow properties by increasing the proportion of branched paraffins. EP-A-0583836 describes a two-step hydrotreatment process in which a Fischer-Tropsch synthesis product is firstly subjected to hydroconversion under conditions such that it undergoes substantially no isomerisation or hydrocracking (this hydrogenates the olefinic and oxygen-containing components), and then at least part of the resultant product is hydroconverted under conditions such that hydrocracking and isomerisation occur to yield a substantially paraffinic hydrocarbon fuel. The desired fraction(s), typically gas oil fraction(s), may subsequently be isolated for instance by distillation.

Other post-synthesis treatments, such as polymerisation, alkylation, distillation, cracking-decarboxylation, isomerisation and hydroreforming, may be employed to modify the properties of Fischer-Tropsch condensation products, as described for instance in U.S. Pat. No. 4,125,566 and U.S. Pat. No. 4,478,955.

Typical catalysts for the Fischer-Tropsch synthesis of paraffinic hydrocarbons comprise, as the catalytically active component, a metal from Group VIII of the periodic table of the elements, in particular ruthenium, iron, cobalt or nickel. Suitable such catalysts are described for instance in EP-A-0583836.

An example of a Fischer-Tropsch based process is the Shells “Gas-to-liquids” or “GtL” technology (formerly known as the SMDS (Shell Middle Distillate Synthesis) and described in “The Shell Middle Distillate Synthesis Process”, van der Burgt et al, paper delivered at the 5th Synfuels Worldwide Symposium, Washington D.C., November 1985, and in the November 1989 publication of the same title from Shell International Petroleum Company Ltd, London, UK). In the latter case, preferred features of the hydroconversion process may be as disclosed therein. This process produces middle distillate range products by conversion of a natural gas into a heavy long chain hydrocarbon (paraffin) wax which can then be hydroconverted and fractionated.

For use in the present invention, a Fischer-Tropsch derived fuel component is preferably any suitable component derived from a gas to liquid synthesis (hereinafter a GtL component), or a component derived from an analogous Fischer-Tropsch synthesis, for instance converting gas, biomass or coal to liquid (hereinafter an XtL component). A Fischer-Tropsch derived component is preferably a GtL component. It may be a BtL (biomass to liquid) component. In general a suitable XtL component may be a middle distillate fuel component, for instance selected from kerosene, diesel and gas oil fractions as known in the art; such components may be generically classed as synthetic process fuels or synthetic process oils. Preferably an XtL component for use as a diesel fuel component is a gas oil.

Diesel fuel components contained in a composition prepared according to the present invention will typically have a density of from 750 to 900 kg/m³, preferably from 800 to 860 kg/m³, at 15° C. (ASTM D-4052 or EN ISO 3675) and/or a VK 40 of from 1.5 to 6.0 mm²/s (ASTM D-445 or EN ISO 3104).

In a diesel fuel composition prepared according to the present invention, the base fuel may itself comprise a mixture of two or more diesel fuel components of the types described above. It may be or contain a so-called “biodiesel” fuel component such as a vegetable oil, hydrogenated vegetable oil or vegetable oil derivative (e.g. a fatty acid ester, in particular a fatty acid methyl ester) or another oxygenate such as an acid, ketone or ester. Such components need not necessarily be bio-derived.

In accordance with the present invention, a VI improving additive may be used to increase the viscosity of a fuel composition. Thus, in a composition prepared according to the first aspect of the present invention, the base fuel(s) may have a relatively low viscosity, and may then be “upgraded” by incorporation of the VI improving additive. A base fuel component which is perhaps not intrinsically beneficial for engine performance may thereby be made to boost performance. Instead or in addition, any detrimental effect that the component might have been expected to have on engine performance may be counteracted, at least partially, by the VI improving additive.

In the case of a diesel fuel composition, for example, the base fuel(s) may be or include relatively low viscosity components such as Fischer-Tropsch or mineral derived kerosene components, Fischer-Tropsch or mineral derived naphtha components, so-called “winter GtL” Fischer-Tropsch derived gas oils, low viscosity mineral oil diesel components or biodiesel components. Such base fuels may for example have a VK 40 (ASTM D-445 or EN ISO 3104) below the maximum permitted by the European diesel fuel specification EN 590, for instance below 4.5 mm²/s, or below 3.5 or 3.2 or 3 mm²/s. In cases they may have a VK 40 below the minimum permitted by EN 590, for example below 2 mm²/s or even below 1.5 mm²/s. The VI improving additive may be pre-diluted in one or more such fuel components, prior to its incorporation into the final automotive fuel composition.

Thus, the first aspect of the present invention may embrace the use of a VI improving additive in a fuel component such as a base fuel, for the purpose of improving the acceleration performance of an internal combustion engine into which the fuel component, or an automotive fuel composition containing the component, is or is intended to be introduced or of a vehicle powered by such an engine. It may embrace the use of a VI improving additive in a fuel component for the purpose of reducing a detrimental effect, caused by the component, on the acceleration performance of an internal combustion engine into which the fuel component, or an automotive fuel composition containing the component, is or is intended to be introduced or of a vehicle powered by such an engine.

By “detrimental effect” on the acceleration performance is typically meant a reduction in the acceleration.

An automotive diesel fuel composition prepared according to the present invention will suitably comply with applicable current standard specification(s) such as for example EN 590 (for Europe) or ASTM D-975 (for the USA). By way of example, the overall fuel composition may have a density from 820 to 845 kg/m³ at 15° C. (ASTM D-4052 or EN ISO 3675); a T95 boiling point (ASTM D-86 or EN ISO 3405) of 360° C. or less; a measured cetane number (ASTM D-613) of 51 or greater; a VK 40 (ASTM D-445 or EN ISO 3104) from 2 to 4.5 mm²/s; a sulphur content (ASTM D-2622 or EN ISO 20846) of 50 mg/kg or less; and/or a polycyclic aromatic hydrocarbons (PAH) content (IP 391(mod)) of less than 11% w/w. Relevant specifications may, however, differ from country to country and from year to year, and may depend on the intended use of the fuel composition.

A diesel fuel composition prepared according to the present invention may contain fuel components with properties outside of these ranges, since the properties of an overall blend may differ, often significantly, from those of its individual constituents.

A diesel fuel composition prepared according to the present invention suitably contains no more than 5000 ppmw (parts per million by weight) of sulphur, typically from 2000 to 5000 ppmw, or from 1000 to 2000 ppmw, or alternatively up to 1000 ppmw. The composition may, for example, be a low or ultra low sulphur fuel, or a sulphur free fuel, for instance containing at most 500 ppmw, preferably no more than 350 ppmw, most preferably no more than 100 or 50 or even 10 ppmw, of sulphur.

An automotive fuel composition prepared according to the present invention, or a base fuel used in such a composition, may be additivated (additive-containing) or unadditivated (additive-free). If additivated, e.g. at the refinery, it will contain minor amounts of one or more additives selected for example from anti-static agents, pipeline drag reducers, flow improvers (e.g. ethylene/vinyl acetate copolymers or acrylate/maleic anhydride copolymers), lubricity additives, antioxidants and wax anti-settling agents. Thus, the composition may contain a minor proportion (preferably 1% w/w or less, more preferably 0.5% w/w (5000 ppmw) or less and most preferably 0.2% w/w (2000 ppmw) or less), of one or more fuel additives, in addition to the VI improving additive.

The composition may for example contain a detergent. Detergent-containing diesel fuel additives are known and commercially available. Such additives may be added to diesel fuels at levels intended to reduce, remove or slow the build up of engine deposits.

Examples of detergents suitable for use in fuel additives for the present purpose include polyolefin substituted succinimides or succinamides of polyamines, for instance polyisobutylene succinimides or polyisobutylene amine succinamides, aliphatic amines, Mannich bases or amines and polyolefin (e.g. polyisobutylene) maleic anhydrides. Succinimide dispersant additives are described for example in GB-A-960493, EP-A-0147240, EP-A-0482253, EP-A-0613938, EP-A-0557516 and WO-A-98/42808. Particularly preferred are polyolefin substituted succinimides such as polyisobutylene succinimides.

A fuel additive mixture useable in a fuel composition prepared according to the present invention may contain other components in addition to the detergent. Examples are lubricity enhancers; dehazers, e.g. alkoxylated phenol formaldehyde polymers; anti-foaming agents (e.g. polyether-modified polysiloxanes); ignition improvers (cetane improvers) (e.g. 2-ethylhexyl nitrate (EHN), cyclohexyl nitrate, di-tert-butyl peroxide and those disclosed in U.S. Pat. No. 4208190 at column 2, line 27 to column 3, line 21) which is herein incorporated by reference; anti-rust agents (e.g. a propane-1,2-diol semi-ester of tetrapropenyl succinic acid, or polyhydric alcohol esters of a succinic acid derivative, the succinic acid derivative having on at least one of its alpha-carbon atoms an unsubstituted or substituted aliphatic hydrocarbon group containing from 20 to 500 carbon atoms, e.g. the pentaerythritol diester of polyisobutylene-substituted succinic acid); corrosion inhibitors; reodorants; anti-wear additives; anti-oxidants (e.g. phenolics such as 2,6-di-tert-butylphenol, or phenylenediamines such as N,N′-di-sec-butyl-p-phenylenediamine); metal deactivators; combustion improvers; static dissipator additives; cold flow improvers; and wax anti-settling agents.

Such a fuel additive mixture may contain a lubricity enhancer, especially when the fuel composition has a low (e.g. 500 ppmw or less) sulphur content. In the additivated fuel composition, the lubricity enhancer is conveniently present at a concentration of less than 1000 ppmw, preferably between 50 and 1000 ppmw, more preferably between 70 and 1000 ppmw. Suitable commercially available lubricity enhancers include ester- and acid-based additives. Other lubricity enhancers are described in the patent literature, in particular in connection with their use in low sulphur content diesel fuels, for example in:
the paper by Danping Wei and H. A. Spikes, “The Lubricity of Diesel Fuels”, Wear, III (1986) 217-235;
WO-A-95/33805—cold flow improvers to enhance lubricity of low sulphur fuels;
WO-A-94/17160—certain esters of a carboxylic acid and an alcohol wherein the acid has from 2 to 50 carbon atoms and the alcohol has 1 or more carbon atoms, particularly glycerol monooleate and di-isodecyl adipate, as fuel additives for wear reduction in a diesel engine injection system;
U.S. Pat. No. 5,490,864—certain dithiophosphoric diester-dialcohols as anti-wear lubricity additives for low sulphur diesel fuels; and
WO-A-98/01516—certain alkyl aromatic compounds having at least one carboxyl group attached to their aromatic nuclei, to confer anti-wear lubricity effects particularly in low sulphur diesel fuels.

It may also be preferred for the fuel composition to contain an anti-foaming agent, more preferably in combination with an anti-rust agent and/or a corrosion inhibitor and/or a lubricity enhancing additive.

Unless otherwise stated, the (active matter) concentration of each such additive component in the additivated fuel composition is preferably up to 10000 ppmw, more preferably in the range of 0.1 to 1000 ppmw, advantageously from 0.1 to 300 ppmw, such as from 0.1 to 150 ppmw.

The (active matter) concentration of any dehazer in the fuel composition will preferably be in the range from 0.1 to 20 ppmw, more preferably from 1 to 15 ppmw, still more preferably from 1 to 10 ppmw, advantageously from 1 to 5 ppmw. The (active matter) concentration of any ignition improver present will preferably be 2600 ppmw or less, more preferably 2000 ppmw or less, conveniently from 300 to 1500 ppmw. The (active matter) concentration of any detergent in the fuel composition will preferably be in the range from 5 to 1500 ppmw, more preferably from 10 to 750 ppmw, most preferably from 20 to 500 ppmw.

If desired, one or more additive components, such as those listed above, may be co-mixed—preferably together with suitable diluent(s)—in an additive concentrate, and the additive concentrate may then be dispersed into a base fuel or fuel composition. The VI improving additive may, in accordance with the present invention, be incorporated into such an additive formulation.

In the case of a diesel fuel composition, for example, the fuel additive mixture will typically contain a detergent, optionally together with other components as described above, and a diesel fuel-compatible diluent, which may be a mineral oil, a solvent such as those sold by Shell companies under the trade mark “SHELLSOL”, a polar solvent such as an ester and, in particular, an alcohol, e.g. hexanol, 2-ethylhexanol, decanol, isotridecanol and alcohol mixtures such as those sold by Shell companies under the trade mark “LINEVOL”, especially LINEVOL 79 alcohol which is a mixture of C₇₋₉ primary alcohols, or a C₁₂₋₁₄ alcohol mixture which is commercially available.

The total content of the additives in the fuel composition may be suitably between 0 and 10000 ppmw and preferably below 5000 ppmw.

In this specification, amounts (concentrations, % v/v, ppmw, % w/w) of components are of active matter, i.e. exclusive of volatile solvents/diluent materials.

Different types and/or concentrations of additives may be appropriate for use in gasoline fuel compositions, which for example may contain polyisobutylene/amine and/or polyisobutylene/amide copolymers as detergent additives.

According to a second aspect of the present invention there is provided the use of a viscosity index (VI) improving additive in an automotive fuel composition, for the purpose of increasing the viscosity of the composition.

In the context of the present invention, an “increase” in viscosity embraces any degree of increase. The increase may be as compared to the viscosity of the fuel composition prior to incorporation of the VI improving additive. It may be as compared to the viscosity of an otherwise analogous fuel composition which is intended (e.g. marketed) for use in an internal combustion engine, in particular a diesel engine, prior to adding a VI improving additive to it.

The present invention may, for example, involve adjusting the viscosity of the fuel composition, using the VI improving additive, in order to achieve a desired target viscosity.

Suitably, the VI improving additive will be used to increase the VK 40 of the fuel composition by at least 0.05 mm²/s, preferably by at least 0.1 or 0.2 or 0.3 or 0.4 mm²/s, in cases by at least 0.5 or 0.6 or 0.7 or 0.8 or 0.9 or even 1 or 1.5 or 2 mm²/s.

Suitably, the VI improving additive, and the concentration at which it is used in the fuel composition, will be such as to cause a reduction in the density of the composition at 15° C. of 5 kg/m³ or less, preferably of 2 kg/m³ or less. Preferably it will be such as to cause no reduction in density. In cases it may be such as to cause an increase in density. Reductions in density may be as compared to the density of the fuel composition prior to incorporation of the VI improving additive. They may be as compared to the density of an otherwise analogous fuel composition which is intended (e.g. marketed) for use in an internal combustion (in particular diesel) engine, prior to adding a VI improving additive to it. Densities may be measured using the standard test method ASTM D-4052 or EN ISO 3675.

Suitably, the VI improving additive, and the concentration at which it is used in the fuel composition, will be such as to cause an increase in the cold filter plugging point (CFPP) of the composition of 10° C. or less, preferably 5 or 2 or 1° C. or less. Preferably it will be such as to cause no increase in CFPP. In cases it may be such as to cause a decrease in CFPP. Increases in CFPP may be as compared to the CFPP of the fuel composition prior to incorporation of the VI improving additive. They may be as compared to the CFPP of an otherwise analogous fuel composition which is intended (e.g. marketed) for use in an internal combustion (in particular diesel) engine, prior to adding a VI improving additive to it. CFPPs may be measured using the standard test method EN 116.

Suitably, the VI improving additive, and the concentration at which it is used in the fuel composition, will be such as to cause an increase in the cloud point of the composition of 10° C. or less, preferably 5 or 2 or 1° C. or less. Preferably it will be such as to cause no increase in cloud point. In cases it may be such as to cause a decrease in cloud point. Increases in cloud point may be as compared to that of the fuel composition prior to incorporation of the VI improving additive. They may be as compared to the cloud point of an otherwise analogous fuel composition which is intended (e.g. marketed) for use in an internal combustion (in particular diesel) engine, prior to adding a VI improving additive to it. Cloud points may be measured using the standard test method EN 23015.

Suitably, the VI improving additive, and the concentration at which it is used in the fuel composition, will be such as to cause an increase in the T95 boiling point of the composition of 5° C. or less, preferably 2 or 1° C. or less. Preferably it will be such as to cause no increase in the T95 boiling point. Increases in T95 boiling point may be as compared to that of the fuel composition prior to incorporation of the VI improving additive. They may be as compared to the T95 boiling point of an otherwise analogous fuel composition which is intended (e.g. marketed) for use in an internal combustion (in particular diesel) engine, prior to adding a VI improving additive to it. T95 boiling points may be measured using the standard test method ASTM D-86 or EN ISO 3405.

As described above in connection with the present invention, a VI improving additive has been found capable of increasing the viscosity of an automotive fuel composition, in particular a diesel fuel composition, by an amount greater than theory would have predicted. Thus, in accordance with the second aspect of the present invention, the VI improving additive may be used in the fuel composition at a concentration lower than that which theory would predict to have been necessary in order to achieve a desired target viscosity. Instead or in addition, it may be used for the purpose of achieving a higher viscosity than that which theory would predict to have been achievable using the same concentration of the VI improving additive.

Thus, in one embodiment of the present invention provides a method for increasing the viscosity of an automotive fuel composition in order to achieve a target minimum viscosity X, which method involves adding to the composition a concentration c of a VI improving additive, wherein c is lower than the minimum concentration c′ of the VI improving additive which theory would predict would need to be added to the composition in order to achieve a viscosity for the composition of X or greater. The fuel composition is preferably a diesel fuel composition.

The theoretical minimum VI improving additive concentration, c′, and its relationship to the viscosity of the resultant composition, are suitably calculated using the formulae given above in connection with the first aspect of the present invention, based on the viscosities of the individual constituents of the composition (i.e. typically the VI improving additive and the base fuel(s) which constitute the remainder of the composition).

The VI improving additive can be used, at a concentration c, in an automotive fuel composition, for the purpose of increasing the viscosity of the composition by an amount which is greater than that which theory would predict to have been achievable using the VI improving additive at concentration c. Again the formulae given above may be used to calculate the theoretically achievable viscosity increase. The viscosity of the composition may for example, using the present invention, be increased by 150% or more, or in cases 200 or 300 or 400 or 450% or more, of the amount by which theory would predict its viscosity to increase using the same VI improving additive at concentration c.

The maximum viscosity of an automotive fuel composition may often be limited by relevant legal and/or commercial specifications—the European diesel fuel specification EN 590, for example, stipulates a maximum VK 40 of 4.5 mm²/s, whilst a Swedish Class 1 diesel fuel must have a VK 40 of no greater than 4.0 mm²/s. Typical commercial automotive diesel fuels are currently manufactured to far lower viscosities than these, however, such as around 2 to 3 mm²/s. Thus, the present invention may involve manipulation of an otherwise standard specification automotive fuel composition, using a VI improving additive, to increase its viscosity so as to improve the acceleration performance of an engine into which it is, or is intended to be, introduced.

In the context of the present invention, “use” of a VI improving additive in a fuel composition means incorporating the VI improving additive into the composition, typically as a blend (i.e. a physical mixture) with one or more fuel components (typically diesel base fuels) and optionally with one or more fuel additives. The VI improving additive is conveniently incorporated before the composition is introduced into an engine which is to be run on the composition. Instead or in addition the use may involve running an engine on the fuel composition containing the VI improving additive, typically by introducing the composition into a combustion chamber of the engine.

The VI improving additive may itself be supplied as a component of a formulation which is suitable for and/or intended for use as a fuel additive, in particular a diesel fuel additive, in which case the VI improving additive may be included in such a formulation for the purpose of influencing its effects on the viscosity of an automotive fuel composition, and/or its effects on the acceleration performance of an engine into which a fuel composition is, or is intended to be, introduced.

Thus, the VI improving additive may be incorporated into an additive formulation or package along with one or more other fuel additives. It may, for instance, be combined, in an additive formulation, with one or more fuel additives selected from detergents, anti-corrosion additives, esters, poly alpha olefins, long chain organic acids, components containing amine or amide active centres, and mixtures thereof. In particular, it may be combined with one or more so-called performance additives, which will typically include at least a detergent.

The VI improving additive may be dosed directly into a fuel component or composition, for example at the refinery. It may be pre-diluted in a suitable fuel component which subsequently forms part of the overall automotive fuel composition.

In accordance with the present invention, two or more VI improving additives may be used in an automotive fuel composition for the purpose(s) described above.

According to the present invention, there is provided a process for the preparation of an automotive fuel composition, which process involves blending an automotive base fuel with a VI improving additive. The blending may be carried out for one or more of the purposes described above in connection with the first to the fourth aspects of the present invention, in particular with respect to the viscosity of the resultant fuel composition and/or its effect on the acceleration performance of an internal combustion engine into which it is, or is intended to be, introduced. The composition may in particular be a diesel fuel composition.

The VI improving additive may, for example, be blended with other components of the composition, in particular the base fuel, at the refinery. Alternatively, it may be added to an automotive fuel composition downstream of the refinery. It may be added as part of an additive package which contains one or more other fuel additives.

A method of operating an internal combustion engine, and/or a vehicle which is powered by such an engine is provided, which method involves introducing into a combustion chamber of the engine a fuel composition prepared in accordance with any one of the first to the fifth aspects of the present invention. Again the fuel composition is preferably introduced for one or more of the purposes described in connection with the first to the fourth aspects of the present invention. Thus, the engine is preferably operated with the fuel composition for the purpose of improving its acceleration performance.

Again the engine may in particular be a diesel engine. It may be a turbo charged engine, in particular a turbo charged diesel engine. The diesel engine may be of the direct injection type, for example of the rotary pump, in-line pump, unit pump, electronic unit injector or common rail type, or of the indirect injection type. It may be a heavy or a light duty diesel engine. It may in particular be an electronic unit direct injection (EUDI) engine.

Throughout the description and claims of this specification, the words “comprise” and “contain” and variations of the words, for example “comprising” and “comprises”, mean “including but not limited to”, and do not exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Preferred features of each aspect of the present invention may be as described in connection with any of the other aspects.

Other features of the present invention will become apparent from the following examples. Generally speaking, the present invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the present invention are to be understood to be applicable to any other aspect, embodiment or example described herein unless incompatible therewith.

Moreover, unless stated otherwise, any feature disclosed herein may be replaced by an alternative feature serving the same or a similar purpose.

The following examples illustrate the properties of automotive fuel compositions prepared according to the present invention, and assess the effects of such compositions on the performance of a turbo charged diesel engine.

For Examples 1 to 5, three different viscosity index improving additives were incorporated into diesel fuel compositions. The additives, and their properties, are shown in Table 1 below. Density and viscosity values are taken from the manufacturers' data sheets.

TABLE 1

| | | | | Sulphur |
|---|---|---|---|---|
| | | | | content |
| | | Density | Viscosity at | (mg/kg) (EN |
| Additive | Source | (kg/m³) | 40° C. (mm²/s) | ISO 20846) |
| SV ™ 206 | Infineum | 824 | 14000 | <1 |
| SV ™ 261 | Infineum | 886 | 16300 | <1 |
| *Kraton ™ | Kraton | ~910 | n/a | <1 |
| G 1650 E | | | | |

*Data for the Kraton ™ additive are estimates, since this material is a solid under the relevant test conditions.

SV™ 206 is a pre-dilution, in the poly alpha olefin PAO6, of 15% w/w solid block copolymers (SV™ 200) based on styrene and isoprene monomers. SV™ 261 is a 15% w/w pre-dilution of similar polymers (SV™ 260) in a highly refined mineral oil. Both additives are widely used in lubricants.

Kraton™ G 1650 E is a styrene-ethylene-butylene block copolymer. It is a solid at 40° C. and is currently used in gels, for instance in cosmetics and candles.

All three additives are widely available commercially.

The additives were incorporated into standard, commercially available diesel test fuels (ex. Shell) and their effects on the properties of the resultant blends were assessed. The three test fuels used, F1 to F3, had the properties shown in Table 2 below. All were petroleum derived, sulphur free fuels.

TABLE 2

| Property | Test method | F1 | F2 | F3 |
|---|---|---|---|---|
| Kinematic viscosity at | EN ISO 3104 | 2.61 | 3.01 | 2.65 |
| 40° C. (mm²/s) | | | | |
| Density at 15° C. | EN ISO 3675 | 834.4 | 836 | 836.5 |
| (kg/m³) | | | | |
| Cloud point (° C.) | EN 23015 | −7 | −8 | −9 |
| CFPP (° C.) | EN 116 | −29 | −28 | −28 |
| T95 boiling point (° C.) | EN ISO 3405 | 357 | 351 | 356 |

Prior to addition of the VI improvers, all three fuels were blended with 10%v/v of a Fischer-Tropsch derived gas oil (ex. Shell Bintulu) and 5%v/v of a commercially available fatty acid methyl ester (ex. ADM) according to DIN EN 14214. Their resultant properties are shown in Table 3 below.

TABLE 3

| | | F1 | F2 | F3 |
|---|---|---|---|---|
| Property | Test method | blend | blend | blend |
| Kinematic viscosity at | EN ISO 3104 | 2.75 | 3.12 | 2.78 |
| 40° C. (mm²/s) | | | | |
| Density at 15° C. | EN ISO 3675 | 831.1 | 831.4 | 833.2 |
| (kg/m³) | | | | |
| CFPP (° C.) | EN 116 | −29 | −30 | −33 |
| T95 boiling point (° C.) | EN ISO 3405 | 351 | 351 | 356 |

### EXAMPLE 1

### Impact of VI Improving Additives on Viscosity

Firstly, the ability of the additives to increase the viscosities of diesel fuel compositions was tested. Each of the additives was added, in a range of concentrations, to the F1 fuel blend. The results, as kinematic viscosities at 40° C., measured using the standard test method EN ISO 3104, are shown in Table 4 below.

TABLE 4

| | | Viscosity | |
|---|---|---|---|
| | Viscosity | with | Viscosity |
| | of F1 blend | 0.5% w/w of | with 1% w/w |
| | alone | additive | of additive |
| Additive | (mm²/s) | (mm²/s) | (mm²/s) |
| SV ™ 206 | 2.75 | 2.96 | 3.19 |
| SV ™ 261 | 2.75 | 2.96 | 3.19 |
| Kraton ™ G 1650 E | 2.75 | 3.73 | 4.7 |

It can be seen that all three additives are capable of causing a significant increase in fuel viscosity, even at relatively low concentrations. By comparison, the lubricant base oil HNR 40D (a naphthenic base oil, ex. Shell Harburg refinery, which has been used in the past to increase the viscosity and density of racing diesel fuels, and which has a VK 40 of 8.007 mm²/s and a density at 15° C. of 879 kg/m³) was found to cause an increase in VK 40 of only 0.14 mm²/s when incorporated into the F1 blend at a concentration of 6% w/w.

The two SVT additives were also tested in the F2 and F3 fuel blends. The effects of the VI improving additives on VK 40 (EN ISO 3104) are shown in Tables 5 and 6 below, for the F2 and F3 blends respectively.

It should be noted that because the SV™ additives contain pre-diluted VI improving polymers, the active ingredient concentration in mixtures containing these additives is in practice significantly lower. For example, a fuel composition containing 0.5% w/w of SVw additive in fact-contains only 0.075% w/w of the active copolymer, and a composition containing 1.0% w/w of SVw additive contains only 0.150% w/w of the active copolymer.

TABLE 5

| | | | Viscosity |
|---|---|---|---|
| | Viscosity | Viscosity | with |
| | of F2 blend | with 1% w/w | 2% w/w of |
| | alone | of additive | additive |
| Additive | (mm²/s) | (mm²/s) | (mm²/s) |
| SV ™ 206 | 3.12 | 3.65 | 4.19 |
| SV ™ 261 | 3.12 | 3.63 | 4.18 |

TABLE 6

| | | Viscosity | Viscosity |
|---|---|---|---|
| | Viscosity | with | with |
| | of F3 blend | 0.5% w/w of | 1% w/w of |
| | alone | additive | additive |
| Additive | (mm²/s) | (mm²/s) | (mm²/s) |
| SV ™ 206 | 2.78 | 3.01 | 3.21 |
| SV ™ 261 | 2.78 | 2.97 | 3.21 |

Again the two VI improving additives can be seen to cause significant increases in viscosity, even at very low active ingredient concentrations.

### EXAMPLE 2

### Effect of VI Improving Additives on Density

Since a reduction in fuel density is generally speaking regarded as detrimental to engine performance, it is also important to establish that an additive used in a diesel fuel composition does not reduce the overall density to an undesirable extent. Moreover, an additive should ideally not increase density to an extent which might take the overall fuel composition outside relevant specifications.

Mixtures were prepared containing the F1 diesel fuel blend and the three additives referred to in Example 1. The densities of these blends were then measured at 15° C. using the standard test method EN ISO 3675. The results are shown in Table 7 below.

TABLE 7

| | Density of | Density with | Density with |
|---|---|---|---|
| | F1 blend | 1% w/w of | 2% w/w of |
| | alone | additive | additive |
| Additive | (kg/m³) | (kg/m³) | (kg/m³) |
| SV ™ 206 | 831.1 | 831.3 | 831.3 |
| SV ™ 261 | 831.1 | 831.4 | 831.3 |
| Kraton ™ G 1650 E | 831.1 | 832.2 | Not tested |

The effects of the two SV™ additives on density were also investigated for the F2 and F3 diesel fuel blends; the results are shown in Tables 8 and 9 respectively.

TABLE 8

| | Density of | Density with | Density with |
|---|---|---|---|
| | F2 blend | 1% w/w of | 2% w/w of |
| | alone | additive | additive |
| Additive | (kg/m³) | (kg/m³) | (kg/m³) |
| SV ™ 206 | 831.4 | 831.3 | 831.3 |
| SV ™ 261 | 831.4 | 831.4 | 831.4 |

TABLE 9

| | Density of | Density with |
|---|---|---|
| | F3 blend | 1% w/w of |
| | alone | additive |
| Additive | (kg/m³) | (kg/m³) |
| SV ™ 206 | 833.2 | 833.1 |
| SV ™ 261 | 833.2 | 833.1 |

It can be seen from Tables 7 to 9 that the two SV™ additives have a more or less neutral effect on fuel density, at treat rates of 2% w/w or below, whilst the Kraton™ additive gives a slight increase in density at a concentration of 1% w/w.

### EXAMPLE 3

### Effect of VI Improving Additives on Cold Flow Properties

The impact of the two SV™ VI improving additives on fuel cold flow properties was investigated in a number of tests.

Fuel samples were prepared containing the F1 diesel fuel blend and the SV™ additives referred to in Example 1. The cold filter plugging points (CFPPs) of these blends were then measured using the standard test method EN 116. The results are shown in Table 10 below.

TABLE 10

| Sample | CFPP (° C.) |
|---|---|
| F1 blend alone | −29 |
| F1 blend + 2% w/w SV ™ 206 | −27 |
| F1 blend + 2% w/w SV ™ 261 | −27 |
| F2 blend alone | −30 |
| F2 blend + 2% w/w SV ™ 206 | −29 |
| F2 blend + 2% w/w SV ™ 261 | −27 |
| F3 blend alone | −33 |
| F3 blend + 2% w/w SV ™ 206 | −32 |
| F3 blend + 2% w/w SV ™ 261 | −32 |

Both additives were found to have only a minor to moderate impact on the CFPPs of the three test fuels.

In additional tests, neither additive was found to have a significant impact on the cloud points (EN 23015) of the test fuels at concentrations of 2% w/w.

Similar results are expected for the Kraton™ VI improving additive.

### EXAMPLE 4

### Effect of VI Improving Additives on Distillation Properties

The distillation properties of a diesel fuel composition often need to comply with legal and/or consumer specifications. For example, according to the European diesel fuel specification EN 590, an automotive diesel fuel must have a T95 (the temperature at which 95% w/w of the fuel is distilled) of no greater than 360° C. It can also be undesirable to include higher concentrations of high boiling fuel components since such components can more readily accumulate in engine oils, causing increased oil levels and possible overflow problems. Thus, whilst any viscosity increasing component is likely to have a higher boiling range than the fuel composition to which it is added, it is desirable for the component to have as little as possible an impact on the T95 boiling point of the overall composition.

In this experiment, the T95 boiling points of various diesel fuel/additive blends were measured using the standard test method EN ISO 3405. The additives used were those shown in Table 1 above, and were incorporated into the F1 blend at a range of concentrations below 4% w/w. The results are shown in Table 11 below.

TABLE 11

| | | T95 boiling | T95 boiling |
|---|---|---|---|
| | T95 boiling | point with | point with |
| | point of F1 | 1% w/w of | 2% w/w of |
| | blend alone | additive | additive |
| Additive | (° C.) | (° C.) | (° C.) |
| SV ™ 206 | 351 | Not tested | 359 |
| SV ™ 261 | 351 | Not tested | 358 |
| Kraton ™ G 1650 E | 351 | 352 | Not tested |

The two SV™ additives were also tested in the F2 and F3 fuel blends. The results are shown in Table 12 below.

TABLE 12

| Sample | T95 boiling point (° C.) |
|---|---|
| F2 blend alone | 351 |
| F2 blend + 2% w/w SV ™ 206 | 365 |
| F2 blend + 2% w/w SV ™ 261 | 361 |
| F3 blend alone | 356 |
| F3 blend + 2% w/w SV ™ 206 | 359 |
| F3 blend + 2% w/w SV ™ 261 | 358 |

It can be seen that at the concentrations proposed according to the present invention, none of the three additives has an unduly detrimental effect on the T95 boiling point of the overall fuel composition. Whilst other viscosity increasing components, for example mineral base oils such as HNR 40D, might cause a lower rate of change of boiling point with concentration, such components would need to be included at far higher levels in order to achieve a workable increase in viscosity (for instance, around 10% w/w in order to achieve a 0.2 mm²/s increase in VK 40, compared to only about 0.2% w/w of Kraton™ G 1650 E to cause the same effect), and as a result the impact on distillation properties of a VI improving additive may in practice be lower than that of a more conventional viscosity increasing component. At 0.2% w/w, for example, the Kraton™ additive causes an increase in T95 boiling point of less than 1° C. in the F1 test fuel blend. The SV™ additives, at similar treat rates, cause increases of the order of 3° C., the higher increase being due to the relatively high boiling mineral oils used as diluents in these additives.

Thus, the VI improvers do not appear to cause any unduly detrimental side effects in diesel fuel compositions, at the concentrations proposed according to the present invention. At the same time, as seen in Example 1, their impact on viscosity is far better than that of other known viscosity increasing components.

### EXAMPLE 5

### Effect of VI Improving Additives on Engine Performance (I)

A diesel fuel composition according to the present invention, containing a VI improving additive, was used in-a diesel powered test vehicle in order to assess its effects on the acceleration performance of the vehicle engine.

The base fuel used as a comparison, F4, was a commercially available petroleum derived maingrade winter grade diesel fuel (ex. Shell, Harburg refinery). It contained no fatty acid methyl esters, no detergent and no Fischer-Tropsch derived fuel components. It complied with the European diesel fuel specification EN 590, and contained less than 10 mg/kg sulphur.

The fuel composition according to the present invention, FI, was a blend of F4 with 1% w/w of Kraton™ G 1650 E, as used in Examples 1 to 4.

The properties of the base fuel F4 are shown in Table 13 below, which also shows the VK 40 and the density of the F4/Kraton™ blend (FI).

TABLE 13

| | | | FI (= F4 + |
|---|---|---|---|
| | | | 1% w/w |
| | | | Kraton ™ G |
| Property | Test method | F4 | 1650 E) |
| Kinematic viscosity at | EN ISO 3104 | 2.895 | 4.827 |
| 40° C. (mm²/s) | | | |
| Density at 15° C. | EN ISO 3675 | 831.6 | 833.9 |
| (kg/m³) | | | |

Table 13 shows that the inclusion of the-VI improving additive, at the 1% w/w concentration used, causes an increase in VK 40 of over 1.9 centistokes (mm²/s).

The following experiments investigated the effect of the increased fuel viscosity on the acceleration performance of a turbo charged diesel engine over a range of engine speeds, thus demonstrating how the present invention might be used to improve acceleration performance, in particular at low engine speeds.

The test vehicle used was a Volkswagen™ Passat™ 2.0 Tdi, registered in 2006, equipped with a Bosch™ unit injector system. It had a power rating of 125 kW at 4200 rpm and a compression ratio of 18.5.

The performance of this vehicle was measured on a chassis dynamometer on a single day without a break. Turbo charge air pressures were measured using a pressure sensor downstream of the turbo charger, whilst engine speeds were logged from the chassis dynamometer. Constant speed power was measured at 1500, 2500 and 3500 rpm. For each test, full throttle accelerations were repeated seven times in fourth gear, and the constant speed power measurements were averaged over 5 seconds.

The fuel test order was:
F4-FI-F4-FI-F4-FI-F4-FI-F4.

Tables 14 to 16 below show the engine power, torque and boost pressure measurements taken at 1500, 2500 and 3500 rpm respectively.

TABLE 14

| | Engine | | | Boost |
|---|---|---|---|---|
| | speed | Power | Torque | pressure |
| Fuel | (rpm) | (kW) | (Nm) | (mbar) |
| F4 | 1501.2 | 41.25 | 262.4 | 1041 |
| FI | 1501.1 | 41.69 | 265.2 | 1046 |
| F4 | 1501.2 | 41.31 | 262.8 | 1024 |
| FI | 1501.4 | 41.58 | 264.5 | 1032 |
| F4 | 1501.5 | 41.21 | 262.1 | 1034 |
| FI | 1501.4 | 41.63 | 264.7 | 1029 |
| F4 | 1501.1 | 41.14 | 261.7 | 1026 |
| FI | 1501.2 | 41.34 | 263.0 | 1033 |
| F4 | 1501.2 | 41.25 | 262.4 | 1022 |

TABLE 15

| | Engine | | | Boost |
|---|---|---|---|---|
| | speed | Power | Torque | pressure |
| Fuel | (rpm) | (kW) | (Nm) | (mbar) |
| F4 | 2501.2 | 84.66 | 323.2 | 1509 |
| FI | 2501.5 | 84.70 | 323.3 | 1509 |
| F4 | 2502.0 | 84.14 | 321.1 | 1499 |
| FI | 2502.0 | 84.20 | 321.4 | 1498 |
| F4 | 2501.6 | 83.96 | 320.5 | 1501 |
| FI | 2501.9 | 84.32 | 321.9 | 1504 |
| F4 | 2502.1 | 84.58 | 322.8 | 1504 |
| FI | 2502.1 | 83.99 | 320.5 | 1492 |
| F4 | 2501.9 | 84.53 | 322.6 | 1491 |

TABLE 16

| | Engine | | | Boost |
|---|---|---|---|---|
| | speed | Power | Torque | pressure |
| Fuel | (rpm) | (kW) | (Nm) | (mbar) |
| F4 | 3502.9 | 106.17 | 289.4 | 1568 |
| FI | 3502.6 | 106.09 | 289.2 | 1529 |
| F4 | 3503.0 | 105.76 | 288.3 | 1493 |
| FI | 3502.5 | 105.58 | 287.9 | 1504 |
| F4 | 3502.5 | 104.96 | 286.2 | 1468 |
| FI | 3502.2 | 104.61 | 285.2 | 1536 |
| F4 | 3502.6 | 105.23 | 286.9 | 1569 |
| FI | 3502.8 | 104.95 | 286.1 | 1532 |
| F4 | 3502.6 | 105.44 | 287.5 | 1564 |

All power data are corrected to account for ambient conditions. All variables were averaged over 5 seconds' measurement.

Table 17 summarises the average differences in engine power, torque and boost pressure, between the two test fuels, at the three engine speeds tested.

TABLE 17

| | Engine | | | Boost |
|---|---|---|---|---|
| | speed | Power | Torque | pressure |
| Fuel | (rpm) | (kW) | (Nm) | (mbar) |
| F4 | 1501.2 | 41.23 | 262.3 | 1029 |
| FI | 1501.3 | 41.56 | 264.4 | 1035 |
| Difference | 0.00% | 0.79% | 0.79% | 0.58% |
| F4 | 2501.8 | 84.37 | 322.1 | 1501 |
| FI | 2501.9 | 84.30 | 321.8 | 1501 |
| Difference | 0.00% | −0.08% | −0.09% | −0.02% |
| F4 | 3502.7 | 105.51 | 287.7 | 1532 |
| FI | 3502.5 | 105.31 | 287.1 | 1525 |
| Difference | −0.01% | −0.20% | −0.19% | −0.47% |

These results demonstrate a clear power benefit of 0.79% at 1500 rpm, for the fuel composition according to the present invention. This difference is no longer evident, however, at the higher engine speeds.

Table 18 below shows the variation of engine power with engine speed during the fourth gear acceleration, for both test fuels.

TABLE 18

| | F4 | FI | Benefit |
|---|---|---|---|
| | (average) | (average) | (average) |
| Acceleration from | (seconds) | (seconds) | (%) |
| 1300-1600 rpm | 2.742 | 2.732 | 0.37 |
| 1600-2200 rpm | 3.225 | 3.194 | 0.97 |
| 2200-3000 rpm | 4.084 | 4.071 | 0.32 |
| 3000-4000 rpm | 6.203 | 6.193 | 0.15 |

These data show that the presence of the VI improver, in the fuel FI according to the present invention, delivers a maximum power benefit of 1% at around 1900 rpm. At very low engine speeds (below about 1400 rpm) there is in this case no apparent power benefit, nor is any benefit observed above about 3500 rpm. However, it is believed that the nature and concentration of the VI improver could be tailored in order to extend the power benefit across a wider range of engine speeds. For example, VI improvers designed for use at higher pressures (such as up to 3000 bar) may be used to provide performance enhancement even under the high pressure conditions experienced at higher engine speeds, as for instance demonstrated in Example 6 below, particularly when present at or around their optimum concentration.

This experiment therefore confirms that a VI improving additive may be included in an automotive fuel composition, in accordance with the present invention, in order to improve the acceleration performance of an engine running on the fuel composition, in particular at lower engine speeds. For the vehicle used in these tests, for example, increases in engine power, engine torque and boost pressure are evident at engine speeds between about 1400 and 1900 rpm when using a fuel composition according to the present invention, as compared to an otherwise identical fuel composition without a VI improving additive.

### EXAMPLE 6

### Effect of VI Improving Additives on Engine Performance (II)

Example 5 was repeated but using four test fuels containing, in accordance with the present invention, varying concentrations of the VI improving additive Kraton™ G 1657 (ex. Kraton). This additive is believed to be better suited to use under high pressure conditions.

The constitutions, densities (DIN EN ISO 3675) and viscosities (DIN EN ISO 3104) of the test fuels, F5 to F8, are shown in Table 19 below. The diesel base fuel used was a standard commercially available diesel base fuel containing less than 10 ppmw sulphur, ex. Shell, which contained no detergent additives, fatty acid methyl esters or Fischer-Tropsch derived fuel components.

TABLE 19

| | F5 | F6 | F7 | F8 |
|---|---|---|---|---|
| Composition (% w/w): | | | | |
| Diesel base fuel | 100.0 | 99.8 | 99.6 | 99.2 |
| Kraton ™ G 1657 | 0.0 | 0.2 | 0.4 | 0.8 |
| Properties: | | | | |
| Density @ 15° C. | 833.8 | 833.9 | 834.1 | 834.3 |
| (kg/m³) | | | | |
| VK 40 (mm²/s) | 2.9566 | 3.3666 | 3.7954 | 4.7867 |

The test vehicle was the same as used in Example 5. Vehicle tractive effort (VTE) tests were conducted at three different engine speeds, and repeated twice for each of the test fuels, on each of two test days. These tests were carried out under wide open throttle conditions. Acceleration times were also measured, between 1200 and 4500 rpm in fourth gear and under road load conditions.

The VTE results are shown in Tables 20 and 21 below, for test days 1 and 2 respectively, and the acceleration time measurements in Table 22. Table 23 summarises the differences in test results between the four test fuels.

TABLE 20

| | VTE (N) | | |
|---|---|---|---|
| Fuel | 1500 rpm | 2500 rpm | 3500 rpm |
| F5 | 3198 | 3863 | 3483 |
| F6 | 3233 | 3915 | 3520 |
| F7 | 3244 | 3910 | 3522 |
| F8 | 3268 | 3894 | 3519 |
| F6 | 3242 | 3918 | 3528 |
| F8 | 3270 | 3908 | 3513 |
| F5 | 3208 | 3903 | 3501 |
| F7 | 3239 | 3904 | 3534 |

TABLE 21

| | VTE (N) | | |
|---|---|---|---|
| Fuel | 1500 rpm | 2500 rpm | 3500 rpm |
| F8 | 3259 | 3915 | 3538 |
| F7 | 3245 | 3929 | 3532 |
| F6 | 3244 | 3919 | 3544 |
| F5 | 3232 | 3907 | 3523 |
| F7 | 3263 | 3928 | 3560 |
| F5 | 3256 | 3930 | 3537 |
| F8 | 3273 | 3921 | 3539 |
| F6 | 3241 | 3935 | 3547 |

TABLE 22

| Day 1 | Acceleration | Day 2 | Acceleration |
|---|---|---|---|
| Fuel | time (s) | Fuel | time (s) |
| F5 | 19.88 | F8 | 19.52 |
| F6 | 19.71 | F7 | 19.46 |
| F7 | 19.64 | F6 | 19.46 |
| F8 | 19.64 | F5 | 19.57 |
| F6 | 19.67 | F7 | 19.41 |
| F8 | 19.78 | F5 | 19.47 |
| F5 | 19.79 | F8 | 19.40 |
| F7 | 19.65 | F6 | 19.45 |

TABLE 23

| | | | | | | | Acceleration | |
|---|---|---|---|---|---|---|---|---|
| | VTE | | VTE | | | | times | |
| | 1500 rpm | | 2500 rpm | | VTE 3500 rpm | | Accel. | Ben- |
| | VTE | Benefit | VTE | Benefit | VTE | Benefit | time | efit |
| Fuel | (N) | (%) | (N) | (%) | (N) | (%) | (s) | (%) |
| F5 | 3223 | n/a | 3901 | n/a | 3511 | n/a | 19.68 | n/a |
| F6 | 3240 | 0.5 | 3922 | 0.5 | 3535 | 0.7 | 19.57 | 0.5 |
| F7 | 3248 | 0.8 | 3918 | 0.4 | 3537 | 0.7 | 19.54 | 0.7 |
| F8 | 3267 | 1.4 | 3909 | 0.2 | 3527 | 0.5 | 19.59 | 0.5 |

These data confirm a power benefit in all three of the engine speed ranges tested, for the fuel compositions containing the VI improving additive. Acceleration times are also reduced for the additivated compositions according to the present invention.

It can be seen that performance benefits depend on additive concentration. However, a higher additive concentration does not necessarily result in improved performance, in particular at higher engine speeds; it is thus possible that for any given VI improving additive, an optimal concentration may be useable to maximise its effect on engine performance.

In the present experiment, for example, fuels F6 (0.2% w/w additive) and F7 (0.4% w/w additive) show especially good performance under all the test conditions, whilst F8 (0.8% w/w additive) gives a smaller performance benefit than F6 and F7, except in the low engine speed range. Thus, for this particular VI improving additive, a suitable treat rate to achieve a performance improvement throughout a range of engine speeds might be between 0.15 and 0.5% w/w, whilst if performance benefit at low engine speeds is the target criterion, a higher additive concentration may be appropriate.

Additional experiments using fuel formulations prepared according to the present invention have indicated that a VI improving additive can cause a greater performance benefit, for any given increase in fuel viscosity, than would be obtained by using a more conventional viscosity increasing component (for example a high viscosity fuel component) to achieve the same viscosity increase.

This may be because the VI improving additives can deliver a higher viscosity increase under injection conditions. This is further explained in Example 7.

### EXAMPLE 7

### Viscosity Increase under Injection Conditions

The ability of VI improving additives to increase viscosity, under injection conditions, was tested by measuring fuel viscosities under the high pressure and temperature that may be expected during fuel injection. The fuel compositions used for these tests are given in Table 24, where the diesel is ex. Shell and does not contain fatty acid methyl ester, the aromatic solvent PLUTOsol™ is ex. Octel Deutschland GmbH, the naphthenic base oil HNR40D is as described above, the GTL is a Fischer-Tropsch derived gas oil ex. Shell Bintulu, and the ‘SV200’ is as described above.

The fuels were blended in such a way that their densities were similar, as can be seen from Table 25. From this Table, it can be seen that the viscosity increase at standard conditions (40° C. and 1 bar) was larger with fuel F10 as compared to fuel F9, than with fuel F11 as compared to fuel F9. In other words, the viscosity increase caused by adding 0.2% m of the VI improving additive was lower than caused by reformulating the fuel with more conventional components. At 80° C. and 1000 bar, which may represent part load conditions, the viscosity increase of F10 and F11, as compared to F9, was nearly equal. At 150° C. and 2000 bar, which is more representative of full load conditions, the viscosity increase of F11 as compared to F9 was much larger than that of F10 as compared to F9. This demonstrates that the diesel viscosity at full load injection conditions may be increased by VI improving additives by a much higher amount than can be expected from the viscosity increase at the conditions of the standard measurement. It is thus expected that VI improving additives give a larger performance benefit for the same standard viscosity increase than reformulating the fuel with more conventional components would.

TABLE 24

| | F9 | Diesel | PLUTOsol ™ | HNR40D | GTL | SV200 |
|---|---|---|---|---|---|---|
| Fuel | (% m) | (% v) | (% v) | (% v) | (% v) | (% m) |
| F9 | | 91.5 | 5.5 | 3.0 | | |
| F10 | | 69.0 | | 26.0 | 5.0 | |
| F11 | 99.8 | | | | | 0.2 |

TABLE 25

| | | Viscosity | Viscosity | Viscosity |
|---|---|---|---|---|
| | Density @ | @ 40° C. & | @ 80° C. & | @ 150° C. & |
| | 15° C. | 1 bar | 1000 bar | 2000 bar |
| Fuel | (kg/m³) | (mm²/s) | (mm²/s) | (mm²/s) |
| F9 | 843.9 | 2.86 | 5.96 | 9.10 |
| F10 | 844.3 | 3.85 | 7.16 | 9.63 |
| F11 | 843.9 | 3.27 | 6.92 | 12.47 |

The fuels mentioned above were tested according to the same test procedure as in Example 5 in a Toyota Avensis 2.0 D-Cat. Results are shown in Table 26. At the two lower engine speeds, the fuel with the VI improver (F11) gave larger benefits than the fuel formulated for higher viscosity with more conventional components. Even though the viscosity increase at normal conditions using the VI improver was only 0.41 mm²/s, whereas the viscosity increase at normal conditions with F10 was 0.99 mm²/s, the improvement in acceleration with F11 was 75% of the improvement in acceleration with F10, demonstrating that the performance improvement by using VI improving additives is larger than can be expected from the increase in viscosity at standard conditions.

TABLE 26

| | | | | | | | Acceleration | |
|---|---|---|---|---|---|---|---|---|
| | VTE | | VTE | | | | times | |
| | 1500 rpm | | 2500 rpm | | VTE 3500 rpm | | | Ben- |
| | VTE | Benefit | VTE | Benefit | VTE | Benefit | Accel. | efit |
| Fuel | (N) | (%) | (N) | (%) | (N) | (%) | time (s) | (%) |
| F9 | 2796 | n/a | 3837 | n/a | 2667 | n/a | 19.23 | n/a |
| F10 | 2829 | 1.2 | 3870 | 0.9 | 2728 | 2.3 | 18.89 | 1.8 |
| F11 | 2835 | 1.4 | 3875 | 1.0 | 2698 | 1.2 | 18.97 | 1.4 |

We claim:

1. A method for increasing the viscosity of an automotive fuel composition in order to achieve a target minimum comprising adding to the composition a concentration c of a VI improving additive which comprises a block copolymer which contains one or more monomer blocks selected from ethylene, propylene, butylene, butadiene, isoprene and styrene monomers, wherein c is lower than the minimum concentration c′ of the VI improving additive which theory would predict would need to be added to the composition in order to achieve a viscosity for the composition of X or greater where c is 0.5% w/w or lower.

2. The method of claim 1 wherein the fuel composition is a diesel fuel composition.

3. The method of claim 1 wherein the copolymer is styrene based.

4. The method of claim 1 wherein the VI improving additive is pre-dissolved in a solvent or fuel component.

5. The method of claim 1 wherein the concentration of the VI improving additive in the fuel composition is from 0.001 to 0.5% w/w.

6. The method of claim 5, wherein the concentration of the VI improving additive in the fuel composition is from 0.15 to 0.5% w.w.

7. The method of claim 5 wherein the concentration of the VI improving additive in the fuel composition is from 0.05 to 0.25% w/w.

8. A method of operating a turbo charger comprising introducing into a combustion chamber of the turbo charger a fuel composition prepared by the method of claim 1.
